(19) United States
(12) Patent Application Publication
(10) Pub. No.: US 2006/0102142 A1
(43) Pub. Date: May 18, 2006

(54) Inlet system of an internal combustion engine

(76) Inventors: Eberhard Holder, Esslingen (DE); Karl-Ernst Hummel, Bietigheim-Bissingen (DE); Bernhard Huurdeman, Freiberg a.N (DE); Arnold Kaden, Remshalden (DE); Zhongxiong Liang, Stuttgart (DE); Herbert Pietrowski, Pleidelsheim (DE); Stephan Wild, Neuenburg (DE)

Correspondence Address: KLAUS J. BACH, 4407 TWIN OAKS DRIVE, MURRYSVILLE, PA, 15668, US

(21) Appl. No.: 11/271,149

(22) Filed: Nov. 12, 2005

(30) Foreign Application Priority Data
Nov. 12, 2004 (DE) 102004054724.6

(51) Int. Cl. F02B 31/00; F02M 35/10; F02D 9/08

(52) U.S. Cl. 123/308; 123/337; 123/184.27

(57) ABSTRACT

In an intake system of an internal combustion engine, with an inlet duct which includes at least one inlet valve, and with a throttle member for swirling the gas flowing to the inlet valve, the throttle member is movable into the inlet duct in an introduction direction and can be moved into a position in which it bears annularly against a wall section of the inlet duct where the inlet duct has a recess accommodating the throttle member.

### BACKGROUND OF THE INVENTION

The invention relates to an inlet system of an internal combustion engine with an inlet duct including an inlet valve and throttling means movably disposed in the inlet duct.

DE 39 36 263 A1 discloses an inlet system, in which a tubular throttle means is arranged in an inlet duct of an internal combustion engine. The tube includes recesses through which gas flowing within the tube can flow to two inlet valves of the internal combustion engine. During this time, the flow path of the gas forms in each case a sharp curve which causes a loss of flow energy.

It is the object of the present invention to provide an inlet system with a throttle means which makes it possible both for gas to flow to an inlet valve with a low energy loss and to provide for an advantageous swirling of the gas.

### SUMMARY OF THE INVENTION

In an intake system of an internal combustion engine, with an inlet duct which includes at least one inlet valve, and with a throttle member for swirling the gas flowing to the inlet valve, the throttle member is movable into the inlet duct in an introduction direction and can be moved into a position in which it bears annularly against a wall section of the inlet duct where the inlet duct has a recess accommodating the throttle member.

The throttle member may be introduced into the recess at least partially, but advantageously completely, so that the flow cross section of the inlet duct can be opened or partially or completely closed by the throttle member. A reduction in the flow cross section of the inlet duct and consequently a loss of flow energy can be at least largely avoided.

The largely closed annular bearing contact area with the duct wall is achieved even when, for closing, there is a small portion of annular bearing contact absent, that is to say a small orifice passage remains between the throttle means and the duct wall through which gas can flow in order to maintain idling operation of the internal combustion engine. The introduction direction may be, for example, a tangential direction, in which the throttle means can be introduced into the inlet duct in a rotational or pivoting movement. The introduction direction may be a single direction which, for example, rules out an oppositely directed movement of two throttle elements of the throttle means.

In a preferred embodiment of the invention, the throttle means can be introduced into an inlet duct so as to reduce a flow cross section and has a recess widening the flow cross section. A high degree of freedom of configuration for achieving an expedient swirling of the gas flowing to the inlet valve can thereby be attained. Any shaping of the flow edge of the throttle means which deviates from an orientation perpendicular to the introduction direction may serve as a recess widening the flow cross section. The recess may be a rounded section, in particular a concavely rounded section, or else an angular indentation of the flow edge.

Expediently, the recess of the throttle means has a flow edge oriented obliquely to the introduction direction. When the throttle means is moved out of the inlet duct, the recess can thereby first influence the flow through the inlet duct on one side of the flow edge, with the result that a swirling movement transverse to the introduction direction can be achieved. Moreover, a more sensitive opening of the inlet duct can be achieved than with a flow edge which is perpendicular to the introduction direction.

Advantageously, the introduction direction is transversely to a gas flow direction. A curved routing of the gas flow and an energy loss resulting therefrom can be at least largely avoided. It is sufficient if the introduction direction is arranged transversely to the gas flow direction in only one part. Expediently, the throttle means can be moved about a pivot axis by means of a pivoting movement, the pivot axis being arranged transversely to the surrounding inlet duct. A transverse orientation means a perpendicular orientation.

An especially good swirling of gas flowing to at least two, in particular, to all inlet valves of a cylinder can be achieved in a simple way if, when a branch of the inlet duct to at least two inlet valves of a cylinder is present, the throttle means is arranged upstream of the branch in the flow direction. The gas is swirled even upstream of the branch, so that an at least largely equal treatment of the valves can be achieved, irrespective of the number of valves.

A streamlined throttle means can be provided if the throttle means comprises a throttle element which can be introduced into the inlet duct and is in the form of a web. A web is a flat element which is longer than it is wide and which may be connected, for example in one piece, to one or more elements.

In a further embodiment of the invention, the throttle means comprises a throttle element which can be introduced into the inlet duct, with two outer edges and with a middle segment arranged between the outer edges, the throttle element being made thicker in the middle segment than at the outer edges. The throttle element may be adapted in its shape to the surrounding duct wall, with the result that only a slight or even no energy loss occurs when gas flows over the throttle element. The edges may be designed to be sharp or rounded.

A further embodiment provides for the throttle means to comprise a hole-shaped orifice. A high degree of freedom of configuration in the generation of swirls can thereby be achieved. The orifice is formed, in particular, into the web. Expediently, with the throttle means projecting at least partially out of the recess of the inlet duct, the orifice can be led completely out of the recess. A reduction in the flow cross section can thereby be achieved, so that the gas, in conjunction with throttling, flows through the orifice, and particularly effective swirling can be generated.

It is proposed, moreover, that the throttle means have in the region of the orifice a structure leading the gas flow to the orifice. A flow can be conducted through the orifice in an energy-efficient manner, for example by means of a countersinking in the region of the orifice or by means of a nozzle-shaped design of the orifice.

If the throttle means is pivotable about a pivot axis and the orifice is oriented obliquely to the pivot axis, a particularly high degree of freedom in the design of the throttle means for achieving particularly effective swirling can be attained.

The invention will become more readily to apparent from the following description of exemplary embodiments of the invention illustrated in the accompanying drawings.

### BRIEF DESCRIPTION OF THE DRAWINGS

FIG. 1 shows an inlet system of an Internal combustion engine with an inlet duct on a diagrammatically indicated cylinder,

FIG. 2 shows a detail of the inlet duct with a throttle means,

FIG. 3 shows the detail of FIG. 2 with a throttle means moved out of a flow cross section,

FIGS. 4a-4d show various positions and designs of a throttle means in an inlet duct,

FIGS. 5a-5f show various variants of a throttle means with different orifices and recesses,

FIG. 6 shows a further throttle means in an inlet duct,

FIGS. 7a-7c show various flow cross sections which can be achieved by means of the throttle means of FIG. 6, and

FIG. 8 shows a flow cross section achieved by a throttle means having an oblique outer flow edge.

### DESCRIPTION OF PARTICULAR EMBODIMENTS

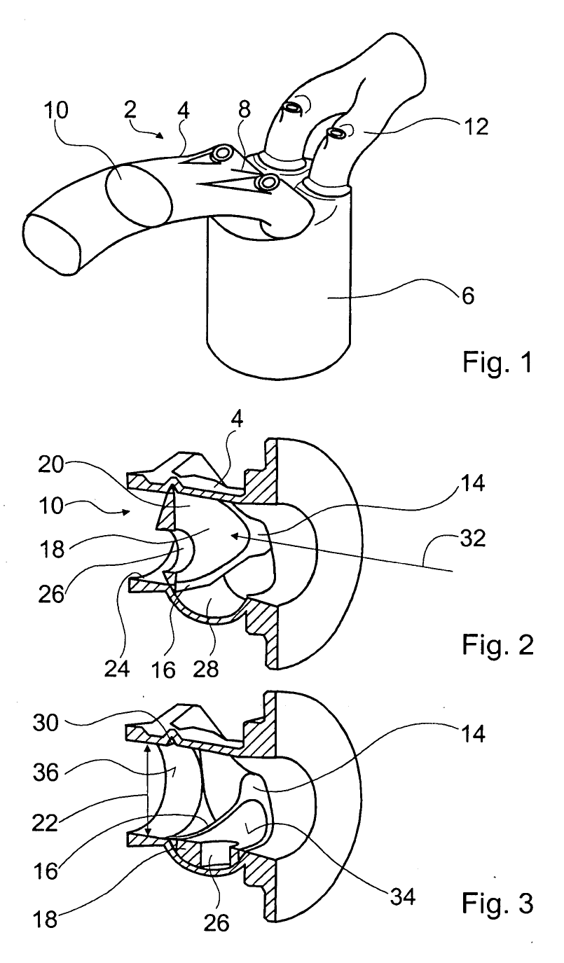

FIG. 1 shows an inlet system 2 of an internal combustion engine, with an inlet duct 4 which extends to a cylinder head, illustrated only diagrammatically, on a diagrammatically illustrated cylinder 6. The inlet duct 4 branches into two part-ducts 8 into which an inlet valve, not shown, is introduced in each case. Arranged in the inlet duct 4 is a throttle means 10 which is illustrated only diagrammatically in FIG. 1. An outlet duct 12 is likewise illustrated with a branch.

The throttle means 10 is shown in FIGS. 2 and 3 in a segment of the inlet duct 4. The throttle means 10 comprises a support structure 14 which is connected to a mechanism for pivoting the throttle means 10 about a pivot axis oriented perpendicularly to the inlet duct 4. Connected in one piece to the support structure 14 is a frame element 16 into which an insert element 18 is inserted. The frame element 16 and the insert element 18 form between the two support structures 14, only one of which is shown in FIGS. 2 and 3, a web 20 which can be pivoted into a duct cross section 22, indicated by an arrow, of the inlet duct 4, so that a remaining flow cross section is narrowed. The web 20 can be pivoted, so as to reduce the flow cross section, to an extent such that a frame element 16, together with the support structure 14, can be brought to bear, when closed, annularly against a duct wall 24 forming a duct cross section 22 provided for the through-flow. Without an orifice 26 in the insert element 18, the inlet duct 4 would be closed completely in this position of the throttle means 10.

The inlet duct 4 comprises two recesses 28, 30 which are arranged opposite one another. The recess 28 is selected with a size such that the web 20 of the throttle means 10 can be introduced completely into this recess 28, so that the throttle means 10 forms completely, and without any narrowing, a duct cross section 22 provided for the through-flow. An inner surface 34, facing a gas flow 32, of the throttle means 10 in this case continues a duct inner surface 36 essentially without transition. A part of the frame element 16 which can be moved into the gas flow 32 can be introduced into the recess 30, so that, in a closed position, as shown in FIG. 2, a flow around the web 20 is avoided.

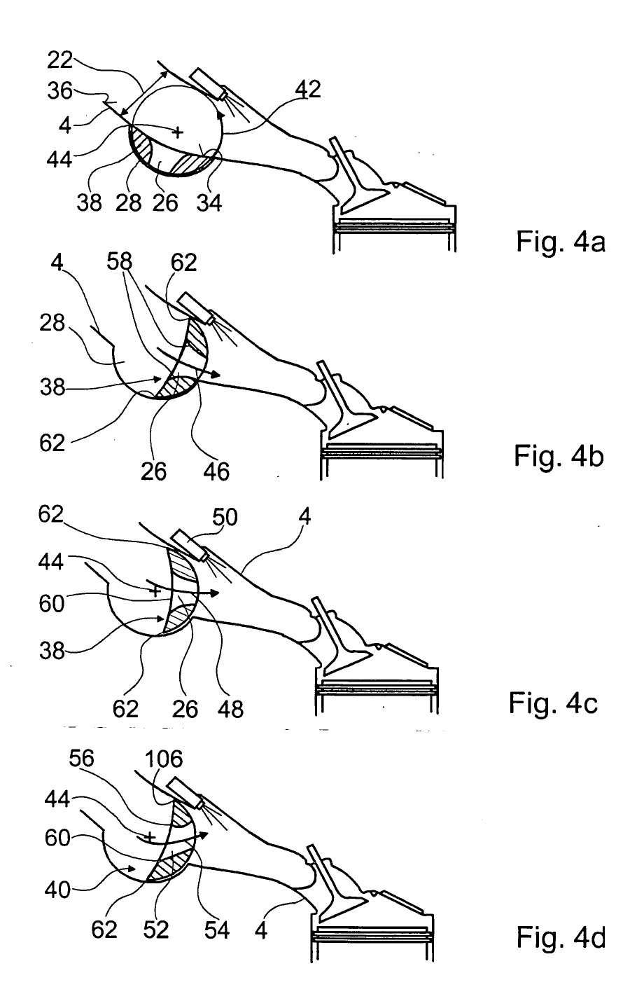

FIGS. 4a-4d illustrate further throttle means 38, 40 in the inlet duct 4. Components which remain essentially identical are numbered basically by the same reference symbols. Furthermore, as regards features and functions which remain the same, reference may be made to the description relating to the exemplary embodiment in FIGS. 1-3. FIG. 4a shows the throttle means 38 in a position led out of the duct cross section 22. The inner surface 34 of the throttle means 38 continues essentially without transition and without narrowing the flow cross section. To reduce the flow cross section and to throttle the gas flow 32, the throttle means 38 can be moved in an introduction direction 42 out of the recess 28 and into the duct cross section 22, as shown, for example, in FIGS. 4b and 4c. The introduction direction 42 lies on the circular path arranged around a pivot axis 44 and is partially perpendicular to the gas flow 32 and to the orientation of the inlet duct 4.

FIG. 4b shows the throttle means 38 in a position in which it bears tightly against the duct inner surface 36 forming the duct cross section 32. A gas flow 46 is possible only through the orifice 26 of the throttle means 38, this gas flow 46 generating a relatively low tumble flow with a swirl axis essentially perpendicular to the paper plane. In a position of the throttle means 38, as shown in FIG. 4c, a gas flow 48 through the orifice 26 is generated which generates a tumble flow having a considerably stronger swirl. In this case, the throttle means 38 remains basically upwards of an injection valve 50 in the flow direction.

A tumble flow having an even stronger swirl is achieved by means of an orifice 52 in the throttle means 40 which is shown in FIG. 4d. This orifice 52 is oriented obliquely to the pivot axis 44 and widens into a structure 56 which conducts a gas flow 54 to the orifice 52. The throttle means 38 shown in FIGS. 4a-4c also comprises such a structure 58, the structure 58 surrounding the orifice 26 in the manner of a rounded countersink.

In order to achieve a good orientation of the gas flows 46, 48, 54, the throttle means 38, 40 are made thicker in a middle segment 60 than at two outer edges 62 surrounding the middle segment 60. This achieves a good orientation of the gas flows 46, 48, 54 in conjunction with a good capability of the throttle means 38, 40 of being introduced into the recess 28.

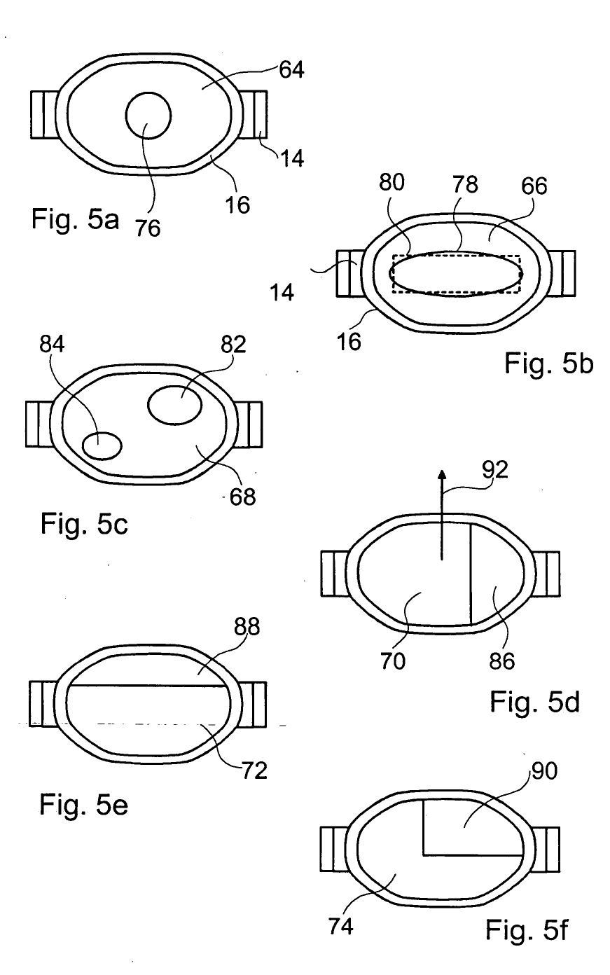

FIGS. 5a-5f show various variants of an insert element 64, 66, 68, 70, 72, 74 in a frame element 16, as shown in FIGS. 2 and 3. It is, of course, also possible to select the frame element 16 and in each case one of the insert elements 64-74 in one piece or in another form of element distribution. Whilst the insert element 64 comprises a circular and centrally arranged orifice 76, the insert element 66 has a likewise centrally arranged, but ovally shaped orifice 78. Instead of the oval orifice 78, a rectangular orifice 80, which is indicated by broken lines in FIG. 5c, may also be envisaged to the same advantage. The insert element 68 from FIG. 5c shows two orifices 82, 84 which are in each case arranged eccentrically. It is also conceivable to design an insert element with only one of the two orifices 82, 84.

The insert element 70 shown in FIG. 5d comprises an orifice 86 which is produced by the insert element 70 being cut away laterally. Such an orifice 76 can generate a strong swirl flow, the swirl axis of which lies in the paper plane, as indicated by the arrow 92. A strong tumble flow can be achieved by means of an orifice 88 which is produced by the insert element 72 being cut away laterally. An orifice 90 in the insert element 74, as shown in FIG. 5f, generates an advantageous mixture of a tumble flow and of a swirl flow, which leads to a good intermixing of the gas flowing through the orifice 90.

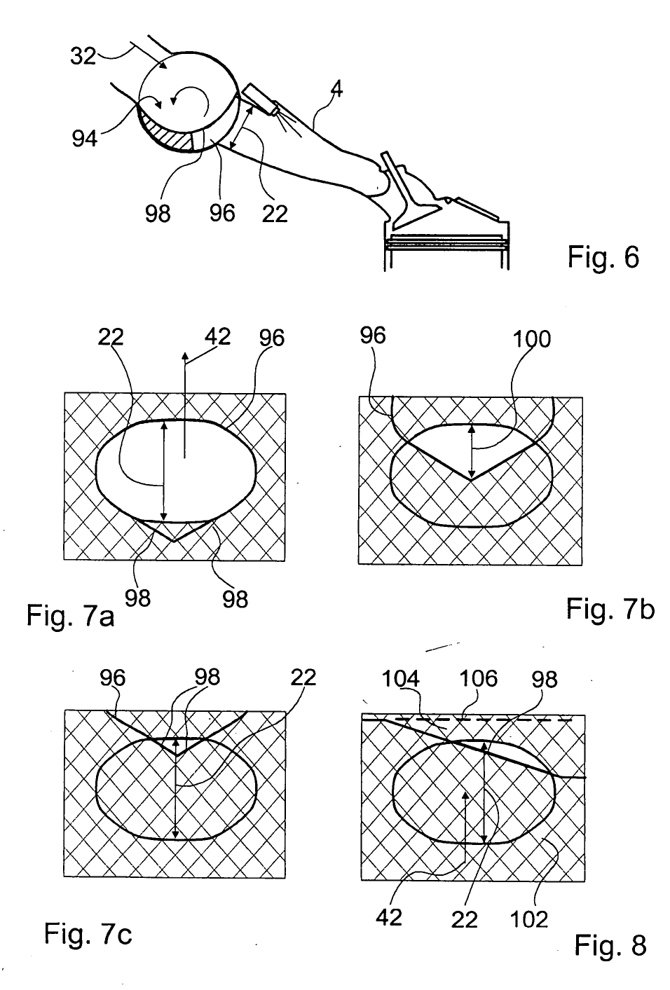

Continuously variable throttling, together with a good swirling of the gas flow 32, can be achieved by a throttle means 94, as shown in FIG. 6. The throttle means 94 comprises an orifice 96, the contour of which is indicated diagrammatically in FIGS. 7a-7c. The screening in FIGS. 7a-7d shows that part of the duct cross section 22 or inlet duct 4 which is not accessible for through-flow. The orifice 96 comprises two flow edges 98 which are oriented obliquely to the introduction direction 42 and which form a point. In the position of the throttle means 94, as shown in FIGS. 6 and 7a, the orifice 96 covers the duct cross section 22 of the inlet duct 4 completely. The throttle means 94 causes essentially no throttling, so that this position is provided for a high load of the internal combustion engine.

When the orifice 96 is led somewhat out of the duct cross section 22 as a result of the movement of the throttle means in the introduction direction 42, as shown in FIG. 7b, this results in a smaller flow cross section 100, indicated by an arrow, which corresponds to medium throttling in the event of a part-load on the internal combustion engine. Very high throttling is shown in FIG. 7c, this being suitable for idling operation of the internal combustion engine. The two oblique flow edges 98 project only in a small part into the duct cross section 22 of the inlet duct 4.

FIG. 8 shows a further possibility of a throttle means 102, illustrated diagrammatically, the oblique flow edge 98 of which is not an integral part of the hole-shaped orifice, as in the throttle means 94, but is formed instead by a recess 104. Without the recess 104, the flow edge 98 would be straight and oriented perpendicularly to the introduction direction 42, as indicated by a flow edge 106 depicted by hatching. Such a flow edge 106 is shown, for example, in FIG. 4d. Like the throttle means 10, 38, 40, the throttle means 102 is also continuously adjustable. This makes it possible to have an optimum orientation of the flow for the respective operating point of the engine.

When throttle means 102 is introduced into the duct cross section 22 in the introduction direction 42, this duct cross section 22 can be narrowed asymmetrically until there is only a small orifice for the passage of a gas flow, as shown in FIG. 8. By the throttle means 102 being introduced further in the introduction direction 42, this orifice or the flow cross section can be closed completely. High throttling for idling operation of the internal combustion engine, as shown in FIG. 8, is thereby associated with advantageous swirling from a combination of a tumble flow and a swirl flow.

What is claimed is:

1. An intake system (2) of an internal combustion engine, with an inlet duct (4) which is connected to at least one inlet valve, and with a throttle means (10, 38, 40, 94, 102) for swirling the gas flowing to the inlet valve, said throttle means being movable into the inlet duct (4) in an introduction direction (42) and movable out of the inlet duct (4) to bear essentially annularly against a duct wall section (24) so as to form a duct cross section (22) provided for the gas flow to the internal combustion engine, said inlet duct (4) having a recess (28) for accommodating the throttle means (10, 38, 40, 94, 102).

2. An intake system (2) according to claim 1, wherein the throttle means (10, 38, 40, 94, 102) is movable into the inlet duct (4) so as to reduce the flow cross section of the inlet duct which has a recess (104) widening the flow cross section.

3. An intake system (2) according to claim 2, wherein the recess (104) of the throttle means (10, 38, 40, 94, 102) has a flow edge (98) oriented obliquely to the induction direction.

4. An intake system (2) according to claim 1, wherein the introduction direction (42) is transversely to a gas flow direction.

5. An intake system (2) according to claim 1, wherein the inlet duct (4) branches into at least two inlet passages of a cylinder (6) and the throttle member (10, 38, 40, 94, 102) is arranged upstream of the branch ducts (8) in the flow direction.

6. An intake system (2) according to claim 1, wherein the throttle member (10, 38, 40, 94, 102) comprises a throttle element capable of being moved into the inlet duct (4) and designed as a web (20).

7. An intake system (2) according to claim 1, wherein the throttle means (10, 38, 40, 94, 102) comprises a throttle element movable into the inlet duct (4), and having two outer edges (62) and a middle segment (60) arranged between the outer edges (62), the throttle element being thicker in the middle segment (60) than at the outer edges (62).

8. An intake system (2) according to claim 1, wherein the throttle means (10, 38, 40, 94) comprises a hole-shaped orifice (26, 52, 76, 78, 80, 82, 84, 86, 88, 90, 96).

9. An intake system according to claim 8, wherein the throttle means (10, 38, 40) has in the region of the orifice a structure (56, 58) leading guiding the intake flow to the orifice (26, 52).

10. An intake system according to claim 8, wherein the throttle means (10, 40, 102) is pivotable about a pivot axis (44), and the orifice (26, 52, 82, 84, 86, 88, 90) is oriented obliquely to the pivot axis (44).
